(19) United States
(12) Patent Application Publication
(10) Pub. No.: US 2025/0350081 A1
(43) Pub. Date: Nov. 13, 2025

(54) CRANK-TYPE PRESSING DEVICE AND TERMINAL CRIMPING APPARATUS INCLUDING THE SAME

(71) Applicant: Shinmaywa Industries, Ltd., Takarazuka-shi, Hyogo (JP)

(72) Inventor: Yoshiki TAKAHASHI, Takarazuka-shi (JP)

(21) Appl. No.: 18/724,724

(22) PCT Filed: Dec. 21, 2022
(86) PCT No.: PCT/JP2022/047164

§ 371 Date: Dec. 30, 2024

(30) Foreign Application Priority Data
Jan. 27, 2022 (JP) 2022-010863

(51) Int. Cl. H01R 43/048

(52) U.S. Cl. CPC H01R 43/048

(57) ABSTRACT

An object of the present invention is to provide a crank-type pressing device that is able to successfully support a rotator and is allowed to be reduced in size. A crank-type pressing device (1) includes: a rotator (15) that rotates around a first rotation axis (C1) upon receiving a driving force from a motor (10); a bearing (16) supporting the rotator (15) such that the rotator (15) is rotatable; a link mechanism (20) including a first pin (21) connected to an eccentric hole (14a) of the rotator (15); and a pressing member (18) connected to a second pin (22) of the link mechanism (20). The bearing (16) and the eccentric hole (14a) are disposed on a pressing axis (V) perpendicular to the first rotation axis (C1).

### TECHNICAL FIELD

The present invention relates to crank-type pressing devices and terminal crimping apparatuses including the devices.

### BACKGROUND ART

A crank-type pressing device known in the art includes: a rotative crankshaft; a link mechanism connected to a portion of the crankshaft eccentric from its rotation center; and a pressing member connected to the link mechanism. The crank-type pressing device presses an object with a linear motion of the pressing member caused by rotation of the crankshaft.

Patent Literature 1, for example, discloses a terminal crimping apparatus including a crank-type pressing device and an applicator. The crank-type pressing device includes: an output shaft serving as a crankshaft; a link mechanism; and a slider serving as a pressing member. The output shaft is rotatably supported by a bearing. The bearing is provided on a portion of the output shaft located toward its root relative to a connection between the output shaft and the link mechanism. An end portion of the output shaft is supported by the bearing in a cantilever manner. The applicator includes: a crimper holder connected to the slider; a crimper attached to the crimper holder; and an anvil. A portion of the output shaft eccentric from its rotation axis is provided with an eccentric pin. The link mechanism is connected to the eccentric pin. Upon rotation of the output shaft, the eccentric pin turns around the rotation axis and moves up and down. In accordance with this movement, the slider moves up and down. Downward movement of the slider moves the crimper toward the anvil. The crimper then presses an electric wire and a terminal supported on the anvil, with the result that the terminal is crimped onto the electric wire.

Patent Literature 2 discloses a crank-type pressing device in which an end portion of a rotation shaft is supported at both extremities by a pair of bearings. In the crank-type pressing device, a disc including an eccentric pin is connected to an end portion of an output shaft of a decelerator. The disc defines the end portion of the rotation shaft. An upper end portion of a crank rod is connected to the eccentric pin. A ram is attached to a lower end portion of the crank rod. Portions of the disc located toward its root and end relative to the eccentric pin are each rotatably supported by an associated one of the bearings.

### CITATION LIST

### Patent Literature

[Patent Literature 1] JP 2007-280792 A
[Patent Literature 2] JP 8-236251 A

### SUMMARY OF INVENTION

### Technical Problem

In the terminal crimping apparatus disclosed in Patent Literature 1, an upward reaction force is exerted on the crimper when the crimper presses the electric wire and the terminal downward. The reaction force is exerted in the form of an upward force on the end portion of the output shaft through the crimper holder, the slider, and the link mechanism. In other words, a force perpendicular to the rotation axis is applied to the end portion of the output shaft during pressing. In the crank-type pressing device disclosed in Patent Literature 1, the end portion of the output shaft is supported by the bearing in a cantilever manner. Thus, a bending moment is exerted on the output shaft upon application of the upward force to the end portion of the output shaft during pressing. If the output shaft is not firmly supported by the bearing, the output shaft might be swung out of its rotation axis. To firmly support the output shaft, however, an auxiliary bearing has to be disposed on the other end of the crankshaft and the crankshaft itself needs to be increased in length such that a sufficient distance is kept between the bearing and the auxiliary bearing. This leads to an increase in the size of the crank-type pressing device.

In the crank-type pressing device disclosed in Patent Literature 2, the portions of the disc located toward its root and end relative to the eccentric pin are both supported by the bearings. Although an upward force is applied to the eccentric pin and a bending moment is exerted on the disc during pressing, the portions of the disc located toward its root and end relative to the eccentric pin are both supported by the bearings in the vicinity of the eccentric pin. This makes it possible to prevent the disc from being swung out of its rotation axis. The crank-type pressing device disclosed in Patent Literature 2, however, requires placing the pair of bearings in the vicinity of the eccentric pin of the disc. Thus, the crank-type pressing device disclosed in Patent Literature 2 is also subject to an increase in device size.

The present invention has been made in view of these points and its object is to provide a crank-type pressing device that is able to successfully support a rotator and is allowed to be reduced in size, and a terminal crimping apparatus including the device.

### Solution to Problem

A crank-type pressing device according to the present invention includes: a driving source to generate a rotative force; a rotator; a bearing; a link mechanism; and a pressing member. The rotator rotates around a first rotation axis upon receiving the rotative force from the driving source. The rotator includes an eccentric portion eccentric from the first rotation axis. The bearing supports the rotator such that the rotator is rotatable. The link mechanism includes: a first connection connected to the eccentric portion of the rotator so as to be rotatable around a second rotation axis parallel to the first rotation axis; a link arm extending from the first connection in a direction perpendicular to the second rotation axis; and a second connection provided in the link arm. The pressing member is connected to the second connection of the link mechanism so as to be rotatable around a third rotation axis parallel to the first rotation axis and the second rotation axis. The pressing member extends along a pressing axis perpendicular to the first rotation axis. The bearing and the eccentric portion are disposed on a same straight line perpendicular to the first rotation axis.

In the crank-type pressing device described above, rotation of the rotator by the driving source causes the pressing member, which is connected to the rotator through the link mechanism, to move along the pressing axis. The pressing member thus presses an object. When the pressing member presses the object, a reaction force is exerted on the pressing member. The reaction force is transmitted to the rotator through the link mechanism, so that a force perpendicular to the first rotation axis is exerted on the eccentric portion of the rotator. In the above-described crank-type pressing device, however, the bearing, supporting the rotator such that rotator is rotatable, and the eccentric portion, on which the force is exerted, are disposed on the same straight line perpendicular to the first rotation axis. Because the bearing and the eccentric portion are not deviated from each other along the first rotation axis, no bending moment, which results from the reaction force, is applied to the rotator. Accordingly, the rotator is unlikely to be swung out of the first rotation axis, with the result that the bearing is able to successfully support the rotator. An end portion of the rotator does not require a pair of bearings to be disposed thereon, resulting in a reduction in the number of components and a reduction in device size.

The bearing and the eccentric portion may be disposed on a straight line parallel to the pressing axis but are preferably disposed on the pressing axis. The bearing is thus able to more stably support the rotator during pressing.

The first connection may include a first pin extending along the second rotation axis. The eccentric portion of the rotator may include an eccentric hole into which the first pin is rotatably inserted. The bearing and the first pin may be disposed on the same straight line perpendicular to the first rotation axis.

The second connection may include a second pin extending along the third rotation axis. The pressing member may be provided with a pin hole into which the second pin is rotatably inserted. The bearing and the second pin may be disposed on the same straight line perpendicular to the first rotation axis.

The driving source may include a motor. The rotator may include: an output shaft connected to the motor; and a disc-shaped wheel connected to an end portion of the output shaft. The bearing may be disposed around the wheel. The first connection of the link mechanism may be connected to the wheel. The link arm of the link mechanism may be disposed on an opposite side of the motor with respect to the pressing axis.

The above-described crank-type pressing device does not require a pair of bearings to be arranged on the end portion of the rotator along the first rotation axis and thus allows the end portion of the rotator to be reduced in size. The features just described allow placement of the link arm in an empty space adjacent to the end portion of the rotator reduced in size. Accordingly, these features enable compact placement of the link mechanism and thus allow a further reduction in device size.

The terminal crimping apparatus according to the present invention includes the crank-type pressing device and an applicator. The applicator includes: a crimper holder attached to the pressing member; a crimper secured to the crimper holder; and an anvil disposed to face the crimper along the pressing axis or a straight line parallel to the pressing axis.

The terminal crimping apparatus described above allows the rotator of the crank-type pressing device to be stably supported and enables the crank-type pressing device to be reduced in size. Accordingly, the above-described terminal crimping apparatus is able to successfully crimp a terminal and is allowed to be reduced in size.

### Effects of Invention

The present invention is able to provide a crank-type pressing device that is capable of successfully supporting a rotator and is allowed to be reduced in size, and a terminal crimping apparatus including the crank-type pressing device.

### BRIEF DESCRIPTION OF DRAWINGS

FIG. 1 is a perspective view of a crank-type pressing device according to one embodiment.

FIG. 2 is a front view of the crank-type pressing device, with its pressing member located at a top dead center.

FIG. 3 is a side view of the crank-type pressing device.

FIG. 4 is a cross-sectional view taken along the line IV-IV of FIG. 2.

FIG. 5 is a front view of the crank-type pressing device, with its pressing member located at a bottom dead center.

FIGS. 6(a) to 6(c) are conceptual diagrams each illustrating whether or not a bending moment is produced when a force perpendicular to a first rotation axis is exerted on a rotator, with FIG. 6(a) illustrating the case where bearings are disposed on portions of the rotator located toward its root relative to a pressing axis, FIG. 6(b) illustrating the case where the bearings are disposed on portions of the rotator located toward its root and end relative to the pressing axis, and FIG. 6(c) illustrating the case where the bearing is disposed on the pressing axis.

### DESCRIPTION OF EMBODIMENTS

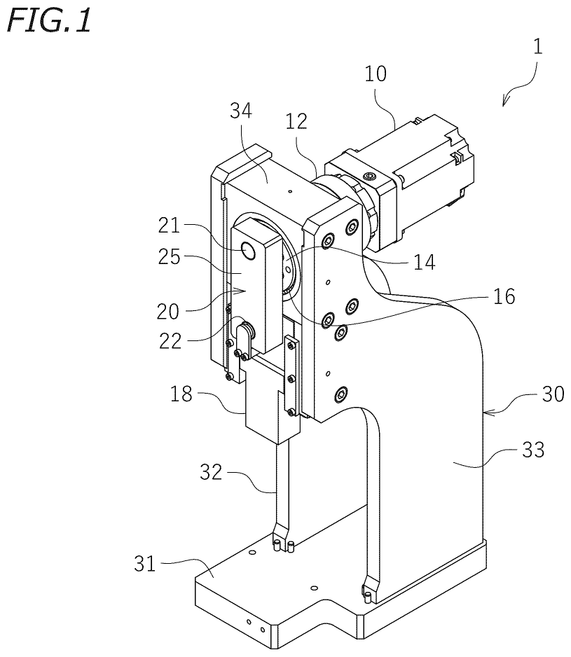

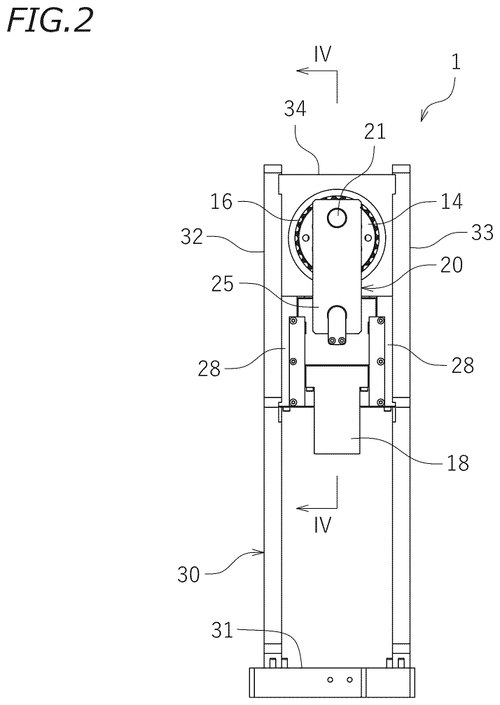

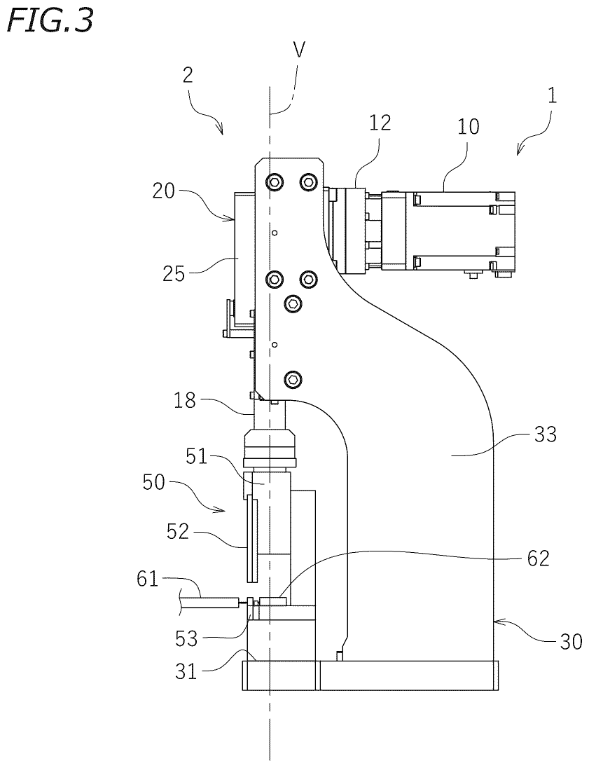

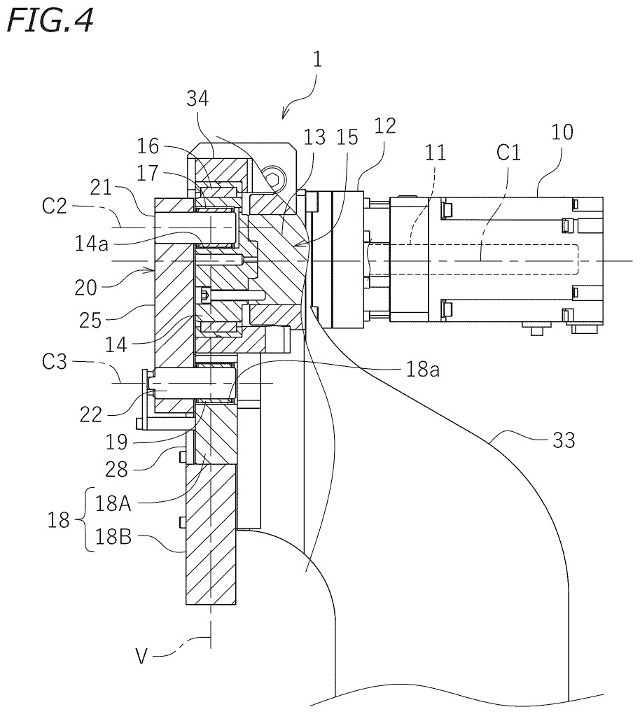

An embodiment of the present invention will be described below with reference to the drawings. FIG. 1 is a perspective view of a crank-type pressing device (which will hereinafter be simply referred to as a “pressing device”) 1 according to the present embodiment. FIG. 2 is a front view of the pressing device 1. FIG. 3 is a side view of a terminal crimping apparatus 2 according to the present embodiment, with an applicator 50 attached to the pressing device 1. FIG. 4 is a cross-sectional view taken along the line IV-IV of FIG. 2.

As illustrated in FIG. 1, the pressing device 1 includes a motor 10, a decelerator 12, a wheel 14, a bearing 16, a link mechanism 20, and a pressing member 18. The pressing device 1 further includes a frame 30 supporting these components.

The frame 30 includes a bottom plate 31, and a left side plate 32 and a right side plate 33 each extending upward from the bottom plate 31. A central plate 34 is disposed between an upper portion of the left side plate 32 and an upper portion of the right side plate 33. The central plate 34 is secured to the left side plate 32 and the right side plate 33.

The motor 10 is an example of a driving source to generate a rotative force. In the present embodiment, the motor 10 includes a servomotor. As illustrated in FIG. 4, the motor 10 includes a rotation shaft 11 extending along a first rotation axis C1. The rotation shaft 11 is connected to the decelerator 12. The decelerator 12 includes an output shaft 13. Rotation of the motor 10 is decelerated by the decelerator 12 and output from the output shaft 13.

The wheel 14 having a disc shape is secured to the output shaft 13. The wheel 14 rotates around the first rotation axis C1 together with the output shaft 13. The first rotation axis C1 is a horizontal line. In the present embodiment, the rotation shaft 11 of the motor 10, the output shaft 13 of the decelerator 12, and the wheel 14 are included in a rotator 15 that rotates upon receiving the rotative force from the motor 10. In the present embodiment, the rotator 15 is provided by combining a plurality of components, and one component of the rotator 15 (e.g., the rotation shaft 11 of the motor 10) and another component of the rotator 15 (e.g., the output shaft 13 of the decelerator 12) do not rotate at the same speed. The components of the rotator 15, however, may each rotate at any speed. The components of the rotator 15 may rotate at the same rotational speed. The rotator 15 may be a one-piece unit. The rotator 15 is configured to rotate around the first rotation axis C1 and extends along the first rotation axis C1. An eccentric hole 14a is defined in a portion of the wheel 14 eccentric from the first rotation axis C1. The eccentric hole 14a is an example of an eccentric portion eccentric from the first rotation axis C1. The eccentric hole 14a extends along a second rotation axis C2 parallel to the first rotation axis C1.

The bearing 16 supports the wheel 14 such that the wheel 14 is rotatable. The central plate 34 is provided with a hole into which the wheel 14 is inserted. The bearing 16 is fitted into this hole. The bearing 16 is disposed around the wheel 14 and interposed between the central plate 34 and the wheel 14. The bearing 16 may be any type of bearing. A needle bearing, a ball bearing, or a sliding bearing, for example, may be usable as the bearing 16. Alternatively, the hole may be formed to be slightly larger than the wheel 14 and may be lubricated with grease or other substance when necessary, so that the hole itself may be used as a sliding bearing.

The link mechanism 20 includes a link arm 25, and a first pin 21 and a second pin 22 each secured to the link arm 25. The first pin 21 is rotatably connected to the eccentric hole 14a of the wheel 14. The first pin 21 is an example of a first connection. The second pin 22 is an example of a second connection. In this embodiment, a bearing 17 is fitted into the eccentric hole 14a of the wheel 14 such that the first pin 21 is rotatably supported by the bearing 17. Similarly to the bearing 16, the bearing 17 may be any type of bearing. A needle bearing, a ball bearing, or a sliding bearing, for example, may be usable as the bearing 17. Alternatively, the eccentric hole 14a itself may be used as a sliding bearing such that the first pin 21 is directly supported by the eccentric hole 14a. The first pin 21 extends along the second rotation axis C2. The link arm 25 extends from the first pin 21 in a direction perpendicular to the second rotation axis C2. The second pin 22 extends along a third rotation axis C3 parallel to the first rotation axis C1 and the second rotation axis C2. In the present embodiment, the first pin 21 and the second pin 22 are components separate from the link arm 25 and assembled thereto. One or both of the first pin 21 and the second pin 22, however, may be integral with the link arm 25.

The pressing member 18 includes: a first component 18A to which the second pin 22 is rotatably connected; and a second component 18B secured to the first component 18A. The first component 18A is provided with a hole 18a such that the second pin 22 is rotatably connected to the hole 18a. In this embodiment, a bearing 19 is fitted into the hole 18a of the first component 18A such that the second pin 22 is rotatably supported by the bearing 19. Similarly to the bearing 16, the bearing 19 may be any type of bearing. A needle bearing, a ball bearing, or a sliding bearing, for example, may be usable as the bearing 19. Alternatively, the hole 18a itself may be used as a sliding bearing such that the second pin 22 is directly supported by the hole 18a. In the present embodiment, the pressing member 18 is provided by assembling together a plurality of components (such as the first component 18A and the second component 18B). The pressing member 18, however, may be provided in any other manner. The pressing member 18 may consist of a single component. The pressing member 18 extends along a pressing axis V perpendicular to the first rotation axis C1. The pressing axis V is a vertical line.

As illustrated in FIG. 2, a guide member 28 is provided on each of the right and left sides of the pressing member 18. The guide members 28 guide up-and-down movement of the pressing member 18. The pressing member 18 is in slidable engagement with the guide members 28.

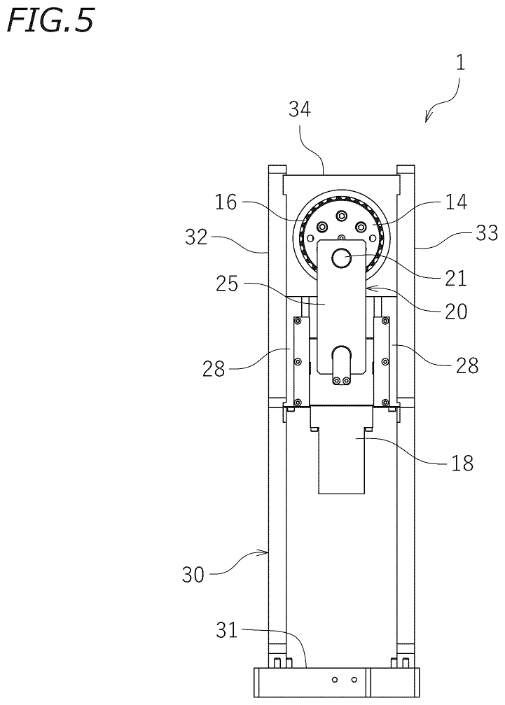

Because the pressing member 18 is connected to the wheel 14 through the link mechanism 20, the pressing member 18 moves up and down in accordance with rotation of the wheel 14. FIG. 2 illustrates the pressing member 18 located at its uppermost position. FIG. 5 illustrates the pressing member 18 located at its lowermost position. In other words, FIGS. 2 and 5 respectively illustrate the pressing member 18 located at a top dead center and a bottom dead center. The pressing member 18 is movable up and down between the top dead center and the bottom dead center.

As illustrated in FIG. 3, the applicator 50 is attached to the pressing device 1. The applicator 50 is a device to crimp a terminal 62 onto an electric wire 61 upon receiving a driving force from the pressing device 1. The pressing device 1 and the applicator 50 are included in the terminal crimping apparatus 2. The applicator 50 includes: a crimper holder 51 connected to the pressing member 18; a crimper 52 secured to the crimper holder 51; and an anvil 53. The crimper holder 51 moves up and down together with the pressing member 18.

The above description has discussed the structures of the pressing device 1 and the terminal crimping apparatus 2. The following description discusses how the pressing device 1 and the terminal crimping apparatus 2 operate.

With the pressing member 18 located at the top dead center, driving the motor 10 transmits the rotative force of the motor 10 to the wheel 14 through the decelerator 12, causing the wheel 14 to rotate. Upon rotation of the wheel 14, the first pin 21 of the link mechanism 20 moves downward such that the pressing member 18 connected to the link mechanism 20 moves downward. The downward movement of the pressing member 18 causes the crimper holder 51, which is connected to the pressing member 18, to move down, so that the crimper 52 secured to the crimper holder 51 moves down. The crimper 52 thus moves toward the anvil 53, with the result that the electric wire 61 and the terminal 62 are sandwiched and crimped between the crimper 52 and the anvil 53.

When crimping the electric wire 61 and the terminal 62, the crimper 52 receives an upward reaction force. The reaction force is transmitted to the pressing member 18 through the crimper holder 51 and then transmitted to the wheel 14 through the link mechanism 20. This exerts an upward force on the wheel 14 along the pressing axis V.

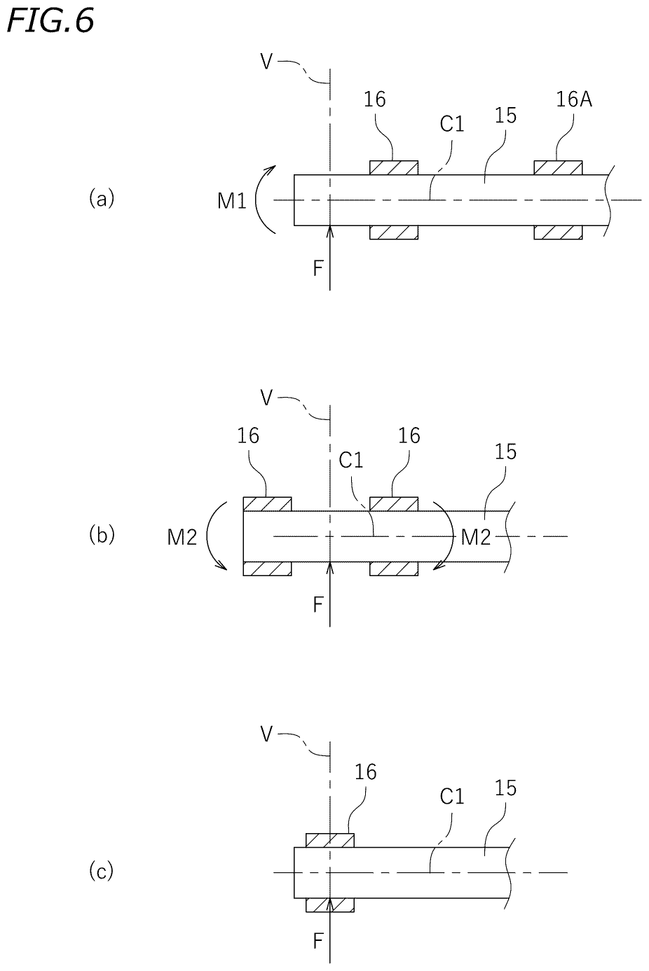

As previously mentioned, the rotation shaft 11 of the motor 10, the output shaft 13 of the decelerator 12, and the wheel 14 are included in the rotator 15. The wheel 14 defines an end portion of the rotator 15. For example, suppose that the bearing 16 supporting the rotator 15 is disposed on a portion of the rotator 15 located toward its root relative to the pressing axis V as illustrated in FIG. 6(a). In this case, when an upward force F is exerted on the rotator 15 along the pressing axis V, a bending moment M1 is applied to the end portion of the rotator 15. This may cause the rotator 15 to be swung out of the first rotation axis C1, with the result that the bearing 16 may fail to successfully support the rotator 15. Adding an auxiliary bearing 16A may stabilize the rotation of the rotator 15. In this case, however, the rotator 15 needs to be increased in length such that a sufficient distance is kept between the bearing 16 and the auxiliary bearing 16A, which leads to an increase in the size of the pressing device 1.

As illustrated in FIG. 6(b), the bearing 16 may conceivably be disposed on each of the portions of the rotator 15 located toward its root and end relative to the pressing axis V. In this case, a bending moment M2 is applied to the end portion of the rotator 15, but the bearings 16 firmly support the rotator 15, making it possible to stabilize the rotation of the rotator 15. This arrangement, however, requires not only the root-side bearing 16 but also the end-side bearing 16. This arrangement thus results in an increase in the size of the pressing device 1 and an increase in the number of components.

When the bearing 16 supporting the end portion of the rotator 15 is disposed on the pressing axis V as illustrated in FIG. 6(c), no bending moment would be applied to the rotator 15 if the upward force F is exerted on the rotator 15 along the pressing axis V. This arrangement is able to stably support the rotator 15 without having to increase the size of the pressing device 1.

In the present embodiment, the rotator 15 is connected to the link mechanism 20 through the eccentric hole 14a of the wheel 14 as illustrated in FIG. 4. During terminal crimping, the rotator 15 receives an upward force along the pressing axis V through the eccentric hole 14a of the wheel 14. In the present embodiment, however, the bearing 16, which supports the wheel 14, and the eccentric hole 14a are both disposed on the pressing axis V. To be more specific, a portion of the rotator 15 that receives a force perpendicular to the first rotation axis C1 (i.e., a portion of the rotator 15 where the eccentric hole 14a is provided) and the bearing 16 supporting the rotator 15 are disposed on the same straight line (i.e., the pressing axis V). Because the bearing 16 and the eccentric hole 14a are not deviated from each other along the first rotation axis C1, no bending moment would be applied to the rotator 15 if the force is exerted on the rotator 15. Accordingly, the rotator 15 would be unlikely to be swung out of the first rotation axis C1 if a bearing is not disposed on each side of the pressing axis V. The present embodiment is able to stably support the rotator 15 and allows the pressing device 1 to be reduced in size.

The present embodiment does not require a pair of bearings to be arranged on the end portion of the rotator 15 along the first rotation axis C1 (see FIG. 6(b)) and thus allows the end portion of the rotator 15 to be reduced in size. The present embodiment affords an additional space adjacent to the end of the rotator 15 (i.e., the left side portion of FIG. 4). In the present embodiment, the link arm 25 of the link mechanism 20 is disposed on the opposite side (which is located in the left side portion of FIG. 4) of the motor (which is located in the right side portion of FIG. 4) with respect to the pressing axis V. In other words, the link arm 25 is disposed in the additional space. Accordingly, the present embodiment enables compact placement of the link mechanism 20 and thus allows the pressing device 1 to be further reduced in size.

The terminal crimping apparatus 2 according to the present embodiment allows the rotator 15 of the pressing device 1 to be stably supported during terminal crimping and is thus able to successfully crimp the terminal 62 onto the electric wire 61. The present embodiment allows the pressing device 1 to be reduced in size, enabling the terminal crimping apparatus 2 to be reduced in size.

Although one embodiment of the present invention has been described thus far, the foregoing embodiment is presented by way of example only. The present invention may be embodied in various other forms.

Although the bearing 16 and the eccentric hole 14a are disposed on the pressing axis V in the foregoing embodiment, the bearing 16 and the eccentric hole 14a are required to be disposed on the same straight line perpendicular to the first rotation axis C1 and thus do not necessarily have to be disposed on the pressing axis V. The bearing 16 and the eccentric hole 14a may be disposed on another straight line parallel to the pressing axis V.

Although the first pin 21 and the second pin 22 are connected to the link arm 25 so as to be non-rotatable relative thereto, one or both of the first pin 21 and the second pin 22 may be connected to the link arm 25 so as to be rotatable relative thereto.

The crank-type pressing device according to the present invention may be incorporated into any apparatus other than a terminal crimping apparatus. The crank-type pressing device according to the present invention may be used for any apparatus that requires a pressing operation.

### REFERENCE SIGNS LIST

1 crank-type pressing device
2 terminal crimping apparatus
10 motor (driving source)
13 output shaft
14 wheel
14a eccentric hole (eccentric portion)
15 rotator
16 bearing
18 pressing member
20 link mechanism
21 first pin (first connection)
22 second pin (second connection)
25 link arm
50 applicator
51 crimper holder
52 crimper
53 anvil
61 electric wire
62 terminal
C1 first rotation axis
C2 second rotation axis
C3 third rotation axis

1. A crank-type pressing device comprising:
a driving source to generate a rotative force;
a rotator that rotates around a first rotation axis upon receiving the rotative force from the driving source, the rotator including an eccentric portion eccentric from the first rotation axis;
a bearing supporting the rotator such that the rotator is rotatable;
a link mechanism including
a first connection connected to the eccentric portion of the rotator so as to be rotatable around a second rotation axis parallel to the first rotation axis,
a link arm extending from the first connection in a direction perpendicular to the second rotation axis, and
a second connection provided in the link arm; and
a pressing member connected to the second connection of the link mechanism so as to be rotatable around a third rotation axis parallel to the first rotation axis and the second rotation axis, the pressing member extending along a pressing axis perpendicular to the first rotation axis, wherein
the bearing and the eccentric portion are disposed on a same straight line perpendicular to the first rotation axis.

2. The crank-type pressing device according to claim 1, wherein
the bearing and the eccentric portion are disposed on the pressing axis.

3. The crank-type pressing device according to claim 1 or 2, wherein
the first connection includes a first pin extending along the second rotation axis,
the eccentric portion of the rotator includes an eccentric hole into which the first pin is rotatably inserted, and
the bearing and the first pin are disposed on the same straight line perpendicular to the first rotation axis.

4. The crank-type pressing device according to any one of claims 1 to 3, wherein
the second connection includes a second pin extending along the third rotation axis,
the pressing member is provided with a pin hole into which the second pin is rotatably inserted, and
the bearing and the second pin are disposed on the same straight line perpendicular to the first rotation axis.

5. The crank-type pressing device according to any one of claims 1 to 4, wherein
the driving source includes a motor,
the rotator includes
an output shaft connected to the motor, and
a disc-shaped wheel connected to an end portion of the output shaft,
the bearing is disposed around the wheel,
the first connection of the link mechanism is connected to the wheel, and
the link arm of the link mechanism is disposed on an opposite side of the motor with respect to the pressing axis.

6. A terminal crimping apparatus comprising:
the crank-type pressing device according to any one of claims 1 to 5; and
an applicator including
a crimper holder attached to the pressing member,
a crimper secured to the crimper holder, and
an anvil disposed to face the crimper along the pressing axis or a straight line parallel to the pressing axis.
